(19) United States
(12) Patent Application Publication
(10) Pub. No.: US 2014/0172131 A1
(43) Pub. Date: Jun. 19, 2014

(54) ALL-IN-ONE COMPUTER WITH KEYBOARD CONTROL SYSTEM

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/017,300

(22) Filed: Sep. 3, 2013

(30) Foreign Application Priority Data
Dec. 18, 2012 (CN) 2012105508069

(51) Int. Cl. G05B 15/02

(52) U.S. Cl. CPC G05B 15/02
USPC 700/90

(57) ABSTRACT

A keyboard control system used in an all-in-one computer includes a sensing module, a processing module, and a control module. The sensing module is used to sense the distance between a user and the sensing module and output a distance. The processing module is connected to the sensing module and outputs control signals according to the distance. The control module is connected to the processing module and a keyboard to rotate the keyboard up and down according to the control signals.

### BACKGROUND

1. Technical Field

The present disclosure relates to an all-in-one (AIO) computer and a keyboard control system of the AIO computer.

2. Description of Related Art

An advantage of an AIO computer is saving space. Typically, an AIO computer does not include a keyboard. Some AIO computers have space to accommodate keyboards, but the keyboards should be manually taken out from the space when in use.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic view of an embodiment of an all-in-one (AIO) computer with a keyboard attached to the AIO computer of the present disclosure.

FIG. 2 is similar to FIG. 1, but shows the keyboard in use.

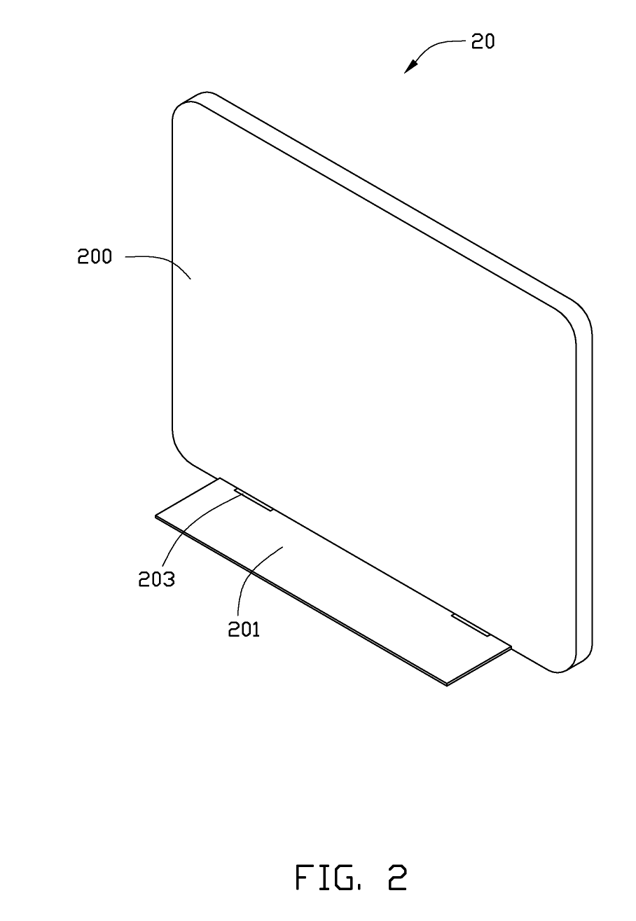

FIG. 3 is a block diagram of the AIO computer of FIG. 1.

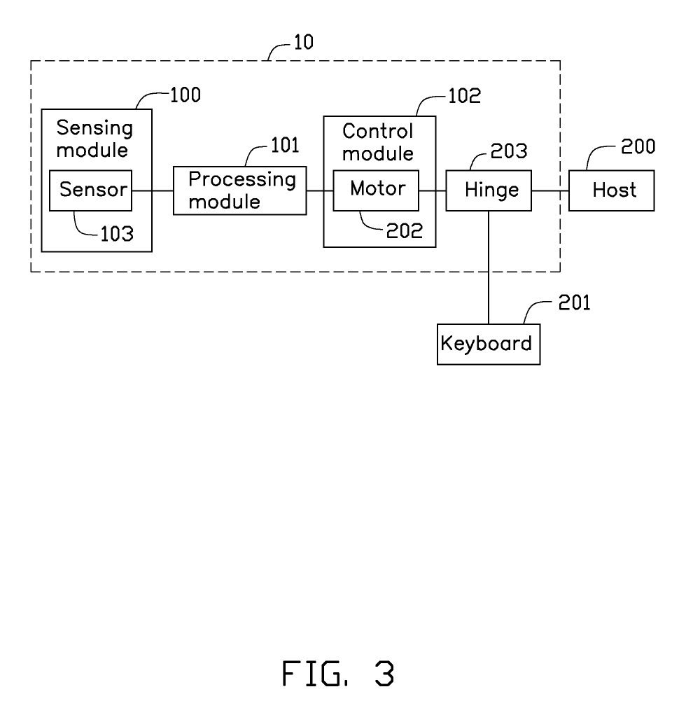

### DETAILED DESCRIPTION

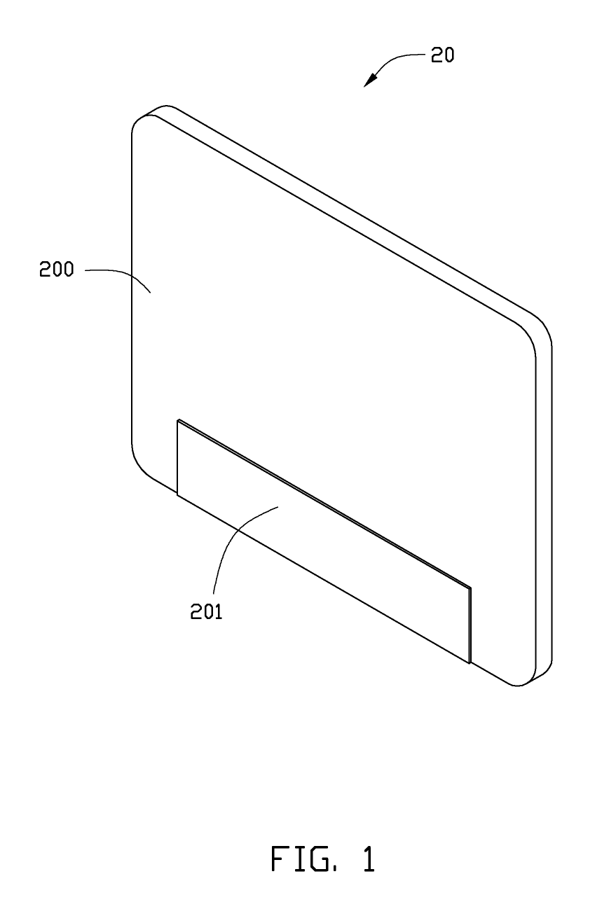

FIG. 1 is a schematic view of an embodiment of an all-in-one (AIO) computer 20 with a keyboard 201 attached to the AIO computer 20 of the present disclosure.

The AIO computer 20 includes a case 200, a keyboard control system 10, and the keyboard 201. The keyboard 201 is fixed on a lower portion of a side of the case 200 using hinges 203. The case 200 includes basic elements like a display, a motherboard, and a hard disk drive. The basic elements are well known, and are not described in detail here.

The keyboard control system 10 includes a sensing module 100, a processing module 101, and a control module 102. The sensing module 100 includes a distance sensor 103 used to sense a distance between a user and the sensing module 100 and output the distance to the processing module 101. The processing module 101 determines whether the user is using the keyboard according to the distance and outputs control signals to the control module 102 according to the determination. The control module 102 is connected to the keyboard 201. The control module 102 controls the keyboard 201 according to the control signals from the processing module 101.

If the distance between a user and the sensing module 100 is less than 0.5 meters, for example, the processing module 101 outputs a first control signal to the control module 102. If the distance between the user and the sensing module 100 is equal to or greater than 0.5 meters, the processing module 101 outputs a second control signal to the control module 102.

In the embodiment, the control module 102 includes a motor 202. The motor 202 is used to rotate the hinges 203 to rotate down or rotate up the keyboard 201. When the motor 202 receives the first control signal, the motor 202 drives the hinges 203 to rotate the keyboard 201 away from the AIO computer 20 for use. When the motor 202 receives the second control signal, the motor 202 drives the hinges 203 to rotate the keyboard 201 to the AIO computer 20 to save space.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A keyboard control system, comprising;
a sensing module sensing a distance between a user and the sensing module;
a processing module connected to the sensing module and outputting control signals according to the distance; and
a control module connected between the processing module and a keyboard, the control module rotating the keyboard up and down according to the control signal.

2. The keyboard control system of claim 1, wherein the sensing module comprises a distance sensor sensing the distance between the user and the sensing module.

3. The keyboard control system of claim 2, wherein the control module comprises a motor.

4. The keyboard control system of claim 3, wherein when the distance between the user and the distance sensor is changed from greater than or equal to a preset value to less than the preset value, the processing module outputs a first control signal to the control module, and the motor controls the keyboard to rotate down; when the distance between the user and the distance sensor is changed from less than the preset value to greater than or equal to the preset value, the processing module outputs a second control signal to the control module, and the motor controls the keyboard to rotate up.

5. An all-in-one (AIO) computer, comprising:
a case;
a keyboard rotatably mounted to the case;
a keyboard control system comprising a sensing module used to sense a distance between a user and the sensing module and output a distance about the distance, wherein the keyboard control system further comprises a processing module connected to the sensing module and outputting control signals according to the distance, and a control module connected between the processing module and the keyboard, the control module rotating the keyboard up and down according to the control signal.

6. The AIO computer of claim 5, wherein the sensing module comprises a distance sensor to sense the distance between the user and the sensing module.

7. The AIO computer of claim 6, wherein the keyboard is mounted to the case through a plurality of hinges, the control module comprises a motor.

8. The AIO computer of claim 7, wherein when the distance between the user and the sensing module is decreased to be less than 0.5 meters, the processing module outputs a first control signal to the control module to control the motor to drive the plurality of hinges to rotate the keyboard away from the AIO computer, when the distance between the user and the sensing module is increased to be equal to or greater than 0.5 meters, the processing module outputs a second control signal to the control module to control the motor to drive the plurality of hinges to rotate the keyboard to the AIO computer.
